(19) United States
(12) Patent Application Publication
(10) Pub. No.: US 2007/0155882 A1
(43) Pub. Date: Jul. 5, 2007

(54) Curable liquid composition, cured film, and antistatic laminate

(76) Inventors: Yoshikazu Yamaguchi, Mie (JP); Shingo Itai, Tokyo (JP); Jiro Ueda, Ibaraki (JP); Takayoshi Tanabe, Ibaraki (JP); John Edmond Southwell, Elgin, IL (US)

Correspondence Address: NIXON & VANDERHYE, PC, 901 NORTH GLEBE ROAD, 11TH FLOOR, ARLINGTON, VA, 22203, US

(21) Appl. No.: 10/552,510

(22) PCT Filed: Apr. 5, 2004
(86) PCT No.: PCT/NL04/00223

§ 371 Date: Jan. 10, 2007

(30) Foreign Application Priority Data
Apr. 10, 2003 (JP) 2003-106096

(51) Int. Cl. C08G 73/10; C08K 3/22

(52) U.S. Cl. 524/409; 524/430

(57) ABSTRACT

To provide a curable liquid composition excelling in storage stability and curability and capable of forming a coat (film) which excels in antistatic properties, hardness, scratch resistance, and transparency on the surface of various substrates, a cured film of the composition, and an antistatic laminate. A curable liquid composition comprising (A) particles including an oxide of at least one element selected from the group consisting of indium, antimony, zinc, and tin as a major component, (B) a compound having at least two polymerizable unsaturated groups in the molecule, (C) a solvent in which solubility of the component (B) is less than 10 wt %, and (D) a solvent in which solubility of the component (B) is 10 wt % or more, the components (A) and (B) being uniformly dispersed or dissolved in the composition.

### FIELD OF THE INVENTION

The present invention relates to a curable liquid composition, a cured film, and an antistatic laminate. More particularly, the present invention relates to a curable liquid composition excelling in curability and capable of forming a coat (film) which excels in antistatic properties, hardness, scratch resistance, and transparency on various substrates such as plastic (polycarbonate, polymethylmethacrylate, polystyrene, polyester, polyolefin, epoxy resin, melamine resin, triacetylcellulose resin, ABS resin, AS resin, norbornene resin, etc.), metal, wood, paper, glass, ceramics, and slate. The present invention also relates to a cured film of the composition and an antistatic laminate.

### PRIOR ART

In order to secure performance and safety in information communication equipment, a film having scratch resistance and adhesion (hard coat) or a film having antistatic properties (antistatic film) has been formed on the surface of the equipment by using a radiation curable composition.

An antireflection film having a multi-layer structure consisting of a low-refractive-index layer and a high-refractive-index layer is formed on the surface of an optical article in order to provide an antireflection function to the optical article.

In recent years, information communication equipment has developed remarkably and been used in a wide range of application fields. Therefore, further improvement of performance and productivity of the hard coat, antistatic film, and antireflection film has been demanded.

In the field of optical articles such as plastic lenses, there has been a demand for prevention of adhesion of dust due to static electricity and a decrease in transmittance due to reflection. In the field of display panels, there has been a demand for prevention of adhesion of dust due to static electricity and reflection of light on the screen.

To deal with these demands, various radiation curable materials have been proposed because of their high productivity and curability at room temperature.

For example, a composition containing a sulfonic acid monomer and a phosphoric acid monomer as ionic conductive components (patent document 1); a composition containing chain-like metal powder (patent document 2); a composition containing tin oxide particles, a polyfunctional acrylate, and a copolymer of methylmethacrylate and a polyether acrylate as major components (patent document 3); a conductive paint composition containing a pigment coated with a conductive polymer (patent document 4); an optical disk material containing a trifunctional acrylate, a compound having a monofunctional ethylenically unsaturated group, a photoinitiator, and conductive powder (patent document 5); a conductive paint containing a hydrolysate of antimony-doped tin oxide particles dispersed by using a silane coupling agent and a tetraalkoxysilane, a photosensitizer, and an organic solvent (patent document 6); a curable liquid composition containing a reaction product of an alkoxysilane having a polymerizable unsaturated group in the molecule with metal oxide particles, a trifunctional acrylic compound, and a radiation polymerization initiator (patent document 7); a paint for forming a transparent conductive film containing conductive oxide micropowder having a primary particle diameter of 100 nm or less, a low-boiling-point solvent which readily allows the conductive oxide micropowder to be dispersed therein, a low-boiling-point solvent which scarcely allows the conductive oxide micropowder to be dispersed therein, and a binder resin (patent document 8); and the like have been proposed.

Patent Document 1

Japanese Patent Application Laid-open No. 47-34539
   Patent Document 2
Japanese Patent Application Laid-open No. 55-78070
   Patent Document 3
Japanese Patent Application Laid-open No. 60-60166
   Patent Document 4
Japanese Patent Application Laid-open No. 2-194071
   Patent Document 5
Japanese Patent Application Laid-open No. 4-172634
   Patent Document 6
Japanese Patent Application Laid-open No. 6-264009
   Patent Document 7
Japanese Patent Application Laid-open No. 2000-143924
   Patent Document 8
Japanese Patent Application Laid-open No. 2001-131485
   Problems to be Solved by the Invention

The above conventional technologies are effective to a certain extent. However, the conventional technologies are not satisfactory in order to produce a cured film which must have all the functions as a hard coat, an antistatic film, and an antireflection film.

For example, the conventional technologies as disclosed in the above patent documents have the following problems. The composition disclosed in the patent document 1, which contains an ion-conductive substance, has insufficient antistatic properties. The antistatic properties of this composition change during drying. The composition disclosed in the patent document 2 has insufficient transparency, since chain-like metal powder having a large particle diameter is dispersed in the composition. Since the composition disclosed in the patent document 3 contains a large amount of an uncurable dispersing agent, the resulting cured film has insufficient hardness. Since the material disclosed in the patent document 5 contains a high concentration of static inorganic particles, transparency is poor. The paint disclosed in the patent document 6 has insufficient long-term storage stability. The patent document 7 does not disclose a process for producing a composition having antistatic properties. In the case of forming a transparent conductive film by applying and drying the paint disclosed in the patent document 8, since the organic matrix consisting of the binder does not have a crosslinked structure, resistance to an organic solvent is insufficient.

A person skilled in the art could have easily arrived at the conclusion that the antistatic properties are improved by increasing the amount of conductive particles. However, an increase in the amount of conductive particles results in a decrease in transparency due to an increase in absorption of visible rays in the resulting cured film. Moreover, curability is decreased due to a decrease in ultraviolet transmissibility. Furthermore, adhesion to a substrate and leveling properties of a coating liquid are impaired. If the amount of conductive particles is decreased, sufficient antistatic properties cannot be obtained.

The present invention has been achieved in view of the above problems. An object of the present invention is to provide a curable liquid composition excelling in curability and capable of forming a coat (film) which excels in antistatic properties, hardness, scratch resistance, and transparency on the surface of various substrates, a cured film of the composition, and an antistatic laminate.

Means for Solving the Problems

The present inventors have conducted extensive studies to solve the above-described problems. As a result, the present inventors have found that the above object can be achieved by a composition which comprises particles including an oxide of a specific element as a major component, a compound having a specific polymerizable unsaturated group, and at least two types of solvents which differ in solubility of the compound. This finding has led to the completion of the present invention.

Specifically, the present invention provides the following curable liquid composition, cured film, and antistatic laminate.
[1] A curable liquid composition comprising:
(A) particles including an oxide of at least one element selected from the group consisting of indium, antimony, zinc, and tin as a major component,
(B) a compound having at least two polymerizable unsaturated groups in the molecule,
(C) a solvent in which solubility of the component (B) is less than 10 wt %, and
(D) a solvent in which solubility of the component (B) is 10 wt % or more, the components (A) and (B) being uniformly dispersed or dissolved in the composition.
[2] The curable liquid composition according to [1], further comprising (E) a photoinitiator.
[3] The curable liquid composition according to [1] or [2], wherein the component (A) is particles including either antimony-doped tin oxide (ATO) or tin-doped indium oxide (ITO) as a major component.
[4] The curable liquid composition according to any of [1] to [3], wherein the component (A) is oxide particles treated by using a surface treatment agent.
[5] The curable liquid composition according to [4], wherein the surface treatment agent is a compound including at least two polymerizable unsaturated groups, a group shown by the following formula (1),
   —X—C(═Y)—NH— (1)
wherein X represents NH, O (oxygen atom), or S (sulfur atom), and Y represents O or S, and a silanol group or a group which forms a silanol group by hydrolysis.
[6] The curable liquid composition according to [5], wherein the group shown by the formula (1) is at least one group selected from the group consisting of —O—C(═O)—NH—, —O—C(═S)—NH—, and —S—C(═O)—NH—.
[7] The curable liquid composition according to any of [1] to [6], wherein the component (C) is water, the content of water in the total solvent in the composition being 0.1-50 wt %.
[8] The curable liquid composition according to any of [1 ] to [6], wherein the component (C) is an organic solvent, the content of the organic solvent in the total solvent in the composition being 5-95 wt %.
[9] A cured film obtained by curing the curable liquid composition according to any of [1 ] to [8], the cured film having surface resistivity of 1×10¹²Ω/ [symbol] or less.
[10] A process for producing a cured film, comprising a step of curing the curable liquid composition according to any of [1] to [8] by applying radiation to the composition.
[11] An antistatic laminate comprising a cured film layer produced by curing the curable liquid composition according to any of [1] to [8].
[12] The antistatic laminate according to [11], wherein the thickness of the layer of the cured film is 0.1-20 □m.

### PREFERRED EMBODIMENT OF THE INVENTION

A preferred embodiment of the present invention is described below in detail.

I. Curable Liquid Composition

The curable liquid composition of the present invention comprises (A) particles including an oxide of at least one element selected from the group consisting of indium, antimony, zinc, and tin as a major component, (B) a compound having at least two polymerizable unsaturated groups in the molecule, (C) a solvent in which solubility of the component (B) is less than 10 wt %, and (D) a solvent in which solubility of the component (B) is 10 wt % or more, the components (A) and (B) being uniformly dispersed or dissolved in the composition. Each component is described below in more detail.

1. Component (A)

The component (A) used in the present invention is particles containing, as a major component, an oxide of at least one element selected from the group consisting of indium, antimony, zinc, and tin from the viewpoint of securing conductivity and transparency of the cured film of the curable liquid composition. These oxide particles are conductive particles.

As specific examples of the oxide particles used as the component (A), at least one type of particles selected from the group consisting of tin-doped indium oxide (ITO), antimony-doped tin oxide (ATO), fluorine-doped tin oxide (FTO), phosphorus-doped tin oxide (PTO), zinc antimonate (AZO), indium-doped zinc oxide (IZO), and zinc oxide can be given. Of these, antimony-doped tin oxide (ATO) and tin-doped indium oxide (ITO) are preferable. These particles may be used either individually or in combination of two or more.

As examples of commercially available products of these oxide particles, T-1 (ITO) (manufactured by Mitsubishi Materials Corporation), Passtran (ITO, ATO) (manufactured by Mitsui Mining & Smelting Co., Ltd.), SN-100P (ATO) (manufactured by Ishihara Sangyo Kaisha, Ltd.), NanoTek ITO (manufactured by C.I. Kasei Co., Ltd.), ATO, FRO (manufactured by Nissan Chemical Industries, Ltd.), and the like can be given.

The oxide particles used as the component (A) may be used in a powder state or a dispersion state in a solvent. It is preferable to use the oxide particles in a dispersion state in a solvent, since uniform dispersibility can be easily obtained.

As examples of commercially available products in which oxide particles used as the component (A) are dispersed in an organic solvent, MTC Filler 12867 (aqueous dispersion of ATO), MHI Filler #8954MS (methyl ethyl ketone dispersion of ATO) (manufactured by Mikuni Color, Ltd.), SN-100D (aqueous dispersion of ATO), SNS-10I (isopropyl alcohol dispersion of ATO), SNS-10B (isobutanol dispersion of ATO), SNS-10M (methyl ethyl ketone dispersion of ATO), FSS-10M (isopropyl alcohol dispersion of ATO) (manufactured by Ishihara Sangyo Kaisha, Ltd.), Celnax CX-Z401M (methanol dispersion of zinc antimonate), Celnax CX-Z200IP (isopropyl alcohol dispersion of zinc antimonate), Suncolloid AMT130S or AMT330S (methanol dispersion of antimony pentoxide) (manufactured by Nissan Chemical Industries, Ltd.), aqueous dispersion, methanol dispersion, isopropyl alcohol dispersion, methyl ethyl ketone dispersion, and toluene dispersion of Passtran type-A (ITO) (Mitsui Mining and Smelting Co., Ltd.), and the like can be given.

The oxide particles used as the component (A) may be oxide particles surface-treated by using a surface treatment agent in order to improve dispersibility in a solvent.

As examples of a surface treatment agent, alkoxysilane compounds, tetrabutoxytitanium, tetrabutoxyzirconium, tetraisopropoxyaluminum, and the like can be given. These compounds may be used either individually or in combination of two or more.

As specific examples of alkoxysilane compounds, compounds having an unsaturated double bond in the molecule such as γ-methacryloxypropyltrimethoxysilane, γ-acryloxypropyltrimethoxysilane, and vinyltrimethoxysilane; compounds having an epoxy group in the molecule such as γ-glycidoxypropyltriethoxysilane and γ-glycidoxypropyltrimethoxysilane; compounds having an amino group in the molecule such as γ-aminopropyltriethoxysilane and γ-aminopropyltrimethoxysilane; compounds having a mercapto group in the molecule such as γ-mercaptopropyltrimethoxysilane and γ-mercaptopropyltriethoxysilane; alkylsilanes such as methyltrimethoxysilane, methyltriethoxysilane, and phenyltrimethoxysilane; and the like can be given. Of these, γ-mercaptopropyltrimethoxysilane, γ-glycidoxypropyltrimethoxysilane, methyltrimethoxysilane, methyltriethoxysilane, and phenyltrimethoxysilane are preferable from the viewpoint of dispersion stability of the surface-treated oxide particles.

As examples of commercially available products of surface-treated oxide particle powder, SN-102P (ATO) and FS-12P (manufactured by Ishihara Sangyo Kaisha, Ltd.), and the like can be given.

As the surface treatment agent, a compound including a functional group which copolymerizes or cross-links with an organic resin (reactive surface treatment agent) is also preferable. As such a surface treatment agent, the above compound including an unsaturated double bond in the molecule, or a compound including at least two polymerizable unsaturated groups, a group shown by the following formula (1),
—X—C(═Y)—NH— (1)
wherein X represents NH, O (oxygen atom), or S (sulfur atom), and Y represents O or S, and a silanol group or a group which forms a silanol group by hydrolysis is preferable.

The group shown by the formula (1) is preferably at least one group selected from the group consisting of a urethane bond [—O—C(═O)—NH—], —O—C(═S)—NH—, and a thiourethane bond [—S—C(═O)—NH—]. As examples of such a surface treatment agent, an alkoxysilane compound which includes a urethane bond [—O—C(═O)NH—] and/or a thiourethane bond [—S—C(═O)NH—] and at least two polymerizable unsaturated groups in the molecule can be given. As a specific example of such a compound, a compound shown by the following formula (2) can be given. 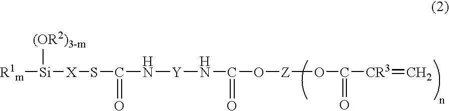
wherein R¹ represents a methyl group, R² represents an alkyl group having 1-6 carbon atoms, R³ represents a hydrogen atom or a methyl group, m represents either 1 or 2, n represents an integer of 1-5, X represents a divalent alkylene group having 1-6 carbon atoms, Y represents a linear, cyclic, or branched divalent hydrocarbon group having 3-14 carbon atoms, Z represents a linear, cyclic, or branched divalent hydrocarbon group having 2-14 carbon atoms. Z may include an ether bond.

The compound shown by the formula (2) may be prepared by reacting a mercaptoalkoxysilane, a diisocyanate, and a hydroxyl group-containing polyfunctional (meth)acrylate.

As a preferable preparation method, a method of reacting a mercaptoalkoxysilane with a diisocyanate to obtain an intermediate containing a thiourethane bond, and reacting the residual isocyanate with a hydroxyl group-containing polyfunctional (meth)acrylate to obtain a product containing a urethane bond can be given.

The same product may be obtained by reacting a diisocyanate with a hydroxyl group-containing polyfunctional (meth)acrylate to obtain an intermediate containing a urethane bond, and reacting the residual isocyanate with a mercaptoalkoxysilane. However, since this method causes the addition reaction of the mercaptoalkoxysilane and the (meth)acrylic group to occur, purity of the product is decreased. Moreover, a gel may be formed.

As examples of the mercaptoalkoxysilane used to produce the compound shown by the formula (2), γ-mercaptopropyltrimethoxysilane, γ-mercaptopropyltriethoxysilane, γ-mercaptopropyltributoxysilane, γ-mercaptopropyidimethylmethoxysilane, γ-mercaptopropylmethyidimethoxysilane, and the like can be given. Of these, γ-mercaptopropyltrimethoxysilane and γ-mercaptopropylmethyldimethoxysilane are preferable.

As examples of commercially available products of the mercaptoalkoxysilane, SH6062 (manufactured by Toray-Dow Corning Silicone Co., Ltd.) can be given.

As examples of diisocyanates, 1,4-butylene diisocyanate, 1,6-hexylene diisocyanate, isophorone diisocyanate, hydrogenated xylylene diisocyanate, hydrogenated bisphenol A diisocyanate, 2,4-toluene diisocyanate, 2,6-toluene diisocyanate, and the like can be given. Of these, 2,4-toluene diisocyanate, isophorone diisocyanate, and hydrogenated xylylene diisocyanate are preferable.

As examples of commercially available products of polyisocyanate compounds, TDI-80/200 TDI-100, MDI-CR100, MDI-CR300, MDI-PH, NDI (manufactured by Mitsui Nisso Urethane Co., Ltd.), Coronate T, Millionate MT, Millionate MR, HDI (manufactured by Nippon Polyurethane Industry Co., Ltd.), Takenate 600 (manufactured by Takeda Chemical Industries, Ltd.), and the like can be given.

As examples of hydroxyl group-containing polyfunctional (meth)acrylates, trimethylolpropane di(meth)acrylate, tris(2-hydroxyethyl)isocyanurate di(meth)acrylate, pentaerythritol tri(meth)acrylate, dipentaerythritol penta(meth)acrylate, and the like can be given. Of these, tris(2-hydroxyethyl)isocyanurate di(meth)acrylate, pentaerythritol tri(meth)acrylate, and dipentaerythritol penta(meth)acrylate are preferable. These compounds form at least two polymerizable unsaturated groups in the compound shown by the formula (2).

The mercaptoalkoxysilane, diisocyanate, and hydroxyl group-containing polyfunctional (meth)acrylate may be used either individually or in combination of two or more.

In the preparation of the compound shown by the formula (2), the mercaptoalkoxysilane, diisocyanate, and hydroxyl group-containing polyfunctional (meth)acrylate are used so that the molar ratio of the diisocyanate to the mercaptoalkoxysilane is preferably 0.8-1.5, and still more preferably 1.0-1.2. If the molar ratio is less than 0.8, storage stability of the composition may be decreased. If the molar ratio exceeds 1.5, dispersibility may be decreased.

The molar ratio of the hydroxyl group-containing (meth)acrylate to the diisocyanate is preferably 1.0-1.5, and still more preferably 1.0-1.2. If the molar ratio is less than 1.0, the composition may gel. If the molar ratio exceeds 1.5, antistatic properties may be decreased.

It is preferable to prepare the compound shown by the formula (2) in dry air in order to prevent anaerobic polymerization of the acrylic group and hydrolysis of the alkoxysilane. The reaction temperature is preferably 0-100° C., and still more preferably 20-80° C.

In the preparation of the compound shown by the formula (2), a conventional catalyst may be used in the urethanization reaction in order to reduce the preparation time. As the catalyst, dibutyltin dilaurate, dioctyltin dilaurate, dibutyltin di(2-ethylhexanoate), and octyltin triacetate can be given. The catalyst is added in an amount of 0.01-1 wt % for the total amount of the catalyst and the diisocyanate.

A heat polymerization inhibitor may be added in the preparation in order to prevent heat polymerization of the compound shown by the formula (2). As examples of heat polymerization inhibitors, p-methoxyphenol, hydroquinone, and the like can be given. The heat polymerization inhibitor is added in an amount of preferably 0.01-1 wt % for the total amount of the heat polymerization inhibitor and the hydroxyl group-containing polyfunctional (meth)acrylate.

The compound shown by the formula (2) may be prepared in a solvent. As the solvent, any solvent which does not react with mercaptoalkoxysilane, diisocyanate, and hydroxyl group-containing polyfunctional (meth)acrylate, and has a boiling point of 200° C. or less may be appropriately selected.

As specific examples of such a solvent, ketones such as methyl ethyl ketone, methyl isobutyl ketone, and cyclohexanone, esters such as ethyl acetate, butyl acetate, and amyl acetate, hydrocarbons such as toluene and xylene, and the like can be given.

In the present invention, the surface-treated oxide particles may be prepared by subjecting the surface treatment agent to hydrolysis in the presence of the oxide particles (A). It is preferable to use a method of adding water to a mixture of the oxide particles (A), surface treatment agent, and organic solvent, and subjecting the mixture to hydrolysis.

In this preparation method, it is presumed that the alkoxy group is converted to a silanol group (Si—OH) by hydrolysis of the surface treatment agent, and the silanol group reacts with a metal hydroxide (M-OH) on the oxide particles to form a metaloxane bond (M-O—Si), whereby the surface treatment agent adheres to the particles.

The surface treatment agent is added in an amount of preferably 0.1-50 parts by weight, and still more preferably 1-35 parts by weight for 100 parts by weight of the oxide particles (A). If the amount of the surface treatment agent is less than 0.1 parts by weight, abrasion resistance of the resulting cured film may be insufficient. If the amount of the surface treatment agent exceeds 50 parts by weight, antistatic properties may be insufficient.

Water is added in an amount of preferably 0.5-1.5 equivalents for the total alkoxy equivalent in the surface treatment agent. Water is added in an amount of preferably 0.5-5.0 parts by weight for 100 parts by weight of the surface treatment agent. Ion-exchanged water or distilled water is preferably used as the water.

Hydrolysis may be carried out by heating the mixture with stirring at a temperature between 0° C. and the boiling point of the components (usually 30-100° C.) for 1-24 hours in the presence of an organic solvent. The organic solvent may not be added in the case of using the oxide particles (A) which are dispersed in an organic solvent. In this case, an organic solvent may optionally be added.

An acid or a base may be added as a catalyst in order to accelerate the reaction during hydrolysis.

As examples of acids, inorganic acids such as hydrochloric acid, nitric acid, sulfuric acid, and phosphoric acid, organic acids such as methanesulfonic acid, toluenesulfonic acid, phthalic acid, malic acid, tartaric acid, malonic acid, formic acid, oxalic acid, methacrylic acid, acrylic acid, and itaconic acid, ammonium salts such as tetramethylammonium hydrochloride and tetrabutylammonium hydrochloride, and the like can be given.

As examples of bases, aqueous ammonia, amines such as triethylamine, tributylamine, and triethanolamine, and the like can be given. It is preferable to use the acid as a catalyst. An organic acid is particularly preferable as a catalyst. The catalyst is added in an amount of preferably 0.001-1 part by weight, and still more preferably 0.01-0.1 part by weight for 100 parts by weight of the alkoxysilane compound.

The hydrolyzate of the surface treatment agent can be effectively caused to adhere to the oxide particles (A) by adding a dehydrating agent at the completion of hydrolysis.

As examples of dehydrating agents, organic carboxylic orthoesters and ketals can be given. Specific examples include methyl orthoformate, ethyl orthoformate, methyl orthoacetate, ethyl orthoacetate, acetone dimethylketal, diethyl ketone dimethylketal, acetophenone dimethylketal, cyclohexanone dimethylketal, cyclohexanone diethylketal, benzophenone dimethylketal, and the like can be given. Of these, organic carboxylic orthoesters are preferable. Methyl orthoformate and ethyl orthoformate are still more preferable.

The dehydrating agent is added in an amount from equimolar to 10-fold molar excess, and preferably from equimolar to 3-fold molar excess of the water content in the composition. If the amount of dehydrating agent is less than equimolar, improvement of storage stability may be insufficient. The dehydrating agent is preferably added after the preparation of the composition. This improves storage stability of the composition and accelerates formation of a chemical bond between the silanol group in the hydrolyzate of the surface treatment agent and the oxide particles (A).

The oxide particles (A) surface-treated by using the surface treatment agent have remarkably superior dispersibility in a solvent. Therefore, it is presumed that the surface treatment agent adheres to the surface of the oxide particles (A) by a chemical bond through a siloxy group (Si—O—).

In the present invention, the oxide particles (A) surface-treated by using the reactive surface treatment agent are referred to as reactive particles (RA).

In the case where the shape of the component (A) is spherical, the primary particle diameter of the component (A) is 0.1 μm or less, and preferably 0.001-0.05 μm as a value determined by measuring the dried powder using a BET absorption method irrespective of whether or not the oxide particles are surface-treated. If the primary particle diameter of the component (A) exceeds 0.1 μm, precipitation may occur in the composition, or flatness and smoothness of the resulting film may be decreased. In the case where the shape of the component (A) is long and narrow such as needle-shaped, the minor axis number average particle diameter is preferably 0.005-0.1 μm and the major axis number average particle diameter is preferably 0.1-3 μm as the number average particle diameters determined by observing the dried powder using an electron microscope. If the major axis particle diameter of the component (A) exceeds 3 μm, precipitation may occur in the composition.

There are no specific limitations to the amount of the component (A) to be added. The amount of the component (A) is preferably 1-50 parts by weight, and still more preferably 3-45 parts by weight for 100 parts by weight of the total amount of the components (A) and (B). This also applies to the case where the component (A) is surface-treated. If the amount of the component (A) is less than 1 part by weight, antistatic properties may be insufficient. If the amount of the component (A) exceeds 50 parts by weight, film formability may be insufficient. The amount of the components (A) and (B) is the amount as the solid content.

2. Component (B)

The component (B) used in the present invention is a compound having at least two polymerizable unsaturated groups in the molecule from the viewpoint of film formability and transparency of the cured film of the curable liquid composition. A cured product having excellent scratch resistance and organic solvent resistance can be obtained by using the component (B).

As specific examples of the component (B), a (meth)acrylate and a vinyl compound can be given.

As examples of (meth)acrylates, trimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, dipentaerythritol hexa(meth)acrylate, glycerol tri(meth)acrylate, tris(2-hydroxyethyl)isocyanurate tri(meth)acrylate, ethylene glycol di(meth)acrylate, 1,3-butanediol di(meth)acrylate, 1,4-butanediol di(meth)acrylate, 1,6-hexanediol di(meth)acrylate, neopentyl glycol di(meth)acrylate, diethylene glycol di(meth)acrylate, triethylene glycol di(meth)acrylate, dipropylene glycol di(meth)acrylate, bis(2-hydroxyethyl)isocyanurate di(meth)acrylate, tricyclodecanediyldimethanol di(meth)acrylate, poly(meth)acrylates of ethylene oxide or propylene oxide addition product of a starting alcohol used to produce these compounds, oligoester (meth)acrylates having at least two (meth)acryloyl groups in the molecule, oligoether(meth)acrylates, oligourethane(meth)acrylates, oligoepoxy(meth)acrylates, and the like can be given.

As examples of vinyl compounds, divinylbenzene, ethylene glycol divinyl ether, diethylene glycol divinyl ether, triethylene glycol divinyl ether, and the like can be given. Of these, dipentaerythritol hexa(meth)acrylate, dipentaerythritol penta(meth)acrylate, trimethylolpropane tri(meth)acrylate, pentaerythritol tri(meth)acrylate, pentaerythritol tetra(meth)acrylate, ditrimethylolpropane tetra(meth)acrylate, tris(2-hydroxyethyl)isocyanurate tri(meth)acrylate, bis(2-hydroxyethyl)isocyanurate di(meth)acrylate, and tricyclodecanediyldimethanol di(meth)acrylate are preferable. The component (B) may be used either individually or in combination of two or more.

The component (B) is added in an amount of preferably 50-99 parts by weight, and still more preferably 55-97 parts by weight for 100 parts by weight of the total amount of the components (A) and (B). If the amount of the component (B) is less than 50 parts by weight, transparency of the resulting cured product may be insufficient. If the amount of the component (B) exceeds 99 parts by weight, antistatic properties may be insufficient.

3. Solvent

The solvent used in the present invention is divided into a solvent in which the solubility of the component (B) is less than 10 wt %, and preferably less than 8 wt % (component (C)), and a solvent in which the solubility of the component (B) is 10 wt % or more, and preferably 40 wt % or more (component (D)) depending on the type of the component (B). Specifically, whether a specific solvent is the component (C) or the component (D) is determined depending on the type of the component (B). The solubility is defined as saturation solubility of the component (B) at 25° C. In more detail, the solubility is determined by measuring the solid content of the component (B) in a solution consisting of the component (B) and the solvent.

The solvent consisting of the solvent (C) and the solvent (D) is added to the curable liquid composition of the present invention so that the total concentration of the components (A) and (B) is 0.5-75 wt %. Specifically, the total amount of the solvent to be added is preferably 33.3-19,900 parts by weight for 100 parts by weight of the total amount of the components (A) and (B). If the total amount of the solvent is less than 33.3 parts by weight, the viscosity of the composition may be increased, whereby applicability may be decreased. If the total amount of the solvent exceeds 19,900 parts by weight, the thickness of the resulting cured product may be excessively decreased, whereby sufficient hardness may not be obtained. However, this value is applied on condition that the components (A) and (B) are uniformly dispersed or dissolved in the composition. Therefore, a specific solvent concentration may change depending on the type of the component (B).

There are no specific limitations to the solvent. It is preferable to use a solvent having a boiling point of 200° C. or less at atmospheric pressure. As specific examples of the solvent, water, alcohol, ketone, ether, ester, hydrocarbon, amide, and the like can be given. The solvent may be used either individually or in combination of two or more.

As examples of alcohols, methanol, ethanol, isopropyl alcohol, isobutanol, n-butanol, tert-butanol, ethoxyethanol, butoxyethanol, diethylene glycol monoethyl ether, benzyl alcohol, phenethyl alcohol, 1-methoxy-2-propanol, and the like can be given. As examples of ketones, acetone, methyl ethyl ketone, methyl isobutyl ketone, cyclohexanone, and the like can be given. As examples of ethers, dibutyl ether, propylene glycol monoethyl ether acetate, and the like can be given. As examples of esters, ethyl acetate, butyl acetate, ethyl lactate, methyl acetoacetoate, ethyl acetoacetate 1-methoxy-2-propanol acetate, and the like can be given. As examples of hydrocarbons, toluene, xylene, and the like can be given. As examples of amides, N,N-dimethylformamide, N,N-dimethylacetamide, N-methylpyrrolidone, and the like can be given.

4. Component (C)

The component (C) used in the present invention is a solvent in which the solubility of the component (B) is less than 10 wt %. Specific examples of the component (C) are given below.

In the case of using dipentaerythritol hexa(meth)acrylate as the component (B), water in which the solubility of the component (B) is less than 0.1 wt % or hexane in which the solubility of component (B) is 0.3 wt % may be used as the component (C).

In the case of using trimethylolpropane tri(meth)acrylate as the component (B), water in which the solubility of the component (B) is less than 0.1 wt % may be used as the component (C).

In the case of using pentaerythritol tri(meth)acrylate as the component (B), water in which the solubility of the component (B) is 0.8 wt % or hexane in which the solubility of the component (B) is 0.6 wt % may be used as the component (C).

In the case of using tricyclodecanediyldimethanol di(meth)acrylate as the component (B), water in which the solubility of the component (B) is less than 0.1 wt % may be used as the component (C).

In the case of using tris(2-hydroxyethyl)isocyanurate tri(meth)acrylate as the component (B), water in which the solubility of the component (B) is 1 wt %, ethanol in which the solubility of the component (B) is 2 wt %, 1-propanol in which the solubility of the component (B) is 8 wt %, isopropyl alcohol in which the solubility of the component (B) is 7 wt %, or n-butanol in which the solubility of the component (B) is 6 wt % may be used as the component (C).

Of these solvents, water and an organic solvent such as ethanol, 1-propanol, isopropyl alcohol, and n-butanol are preferable from the viewpoint of conductivity of the cured product of the curable liquid composition.

In the present invention, in the case where the component (C) is water, the content of water in the total solvent in the composition is preferably 0.1-50 wt %, and still more preferably 5-30 wt %. In the case where the component (C) is an organic solvent, the content of the organic solvent in the total solvent in the composition is preferably 5-95 wt %, and still more preferably 8-90 wt %.

5. Component (D)

The component (D) used in the present invention is a solvent in which the solubility of the component (B) is 10 wt % or more. Specific examples of the component (D) are given below.

In the case where dipentaerythritol hexa(meth)acrylate, trimethylolpropane tri(meth)acrylate, or pentaerythritol tri(meth)acrylate is used as the component (B), alcohols such as methanol, ethanol, 1-propanol, isopropyl alcohol, isobutanol, n-butanol, tert-butanol, ethoxyethanol, butoxyethanol, diethylene glycol monoethyl ether, and diacetone alcohol; ketones such as acetone, methyl ethyl ketone, methyl isobutyl ketone, cyclohexanone, and methyl amyl ketone; ethers such as dibutyl ether, propylene glycol monoethyl ether, and propylene glycol monoethyl ether acetate; esters such as ethyl acetate, butyl acetate, ethyl lactate, methyl acetoacetoate, and ethyl acetoacetate; hydrocarbons such as toluene and xylene; amides such as N,N-dimethylformamide, N,N-dimethylacetamide, and N-methylpyrrolidone; and the like may be used as the component (D).

In the case where tricyclodecanediyidimethanol di(meth)acrylate is used as the component (B), the above alcohol, ketone, ether, ester, amide, hydrocarbon such as hexane, toluene, and xylene, and the like may be used as the component (D).

In the case where tris(2-hydroxyethyl)isocyanurate tri(meth)acrylate is used as the component (B), an alcohol such as methanol, ketone, ether, ester, hydrocarbon, amide, and the like may be used as the component (D).

Of these solvents, methanol, ethanol, methyl ethyl ketone, methyl isobutyl ketone, propylene glycol monoethyl ether, and propylene glycol monoethyl ether acetate are preferable from the viewpoint of liquid stability of the curable liquid composition.

It is preferable that the boiling point of the component (C) be higher than the boiling point of the component (D).

In a preferred embodiment, the solid content of the compositions according to the invention is at least 15%, more preferably at least 40%, most preferably more than 50%.

6. Component (E)

The curable liquid composition of the present invention is cured by merely applying radiation. In order to further increase the cure speed, a photoinitiator may be added as the component (E).

In the present invention, radiation refers to visible rays, ultraviolet rays, deep ultraviolet rays, X-rays, electron beams, □-rays, □-rays, □-rays, and the like.

The component (E) is added in an amount of preferably 0.1-15 parts by weight, and still more preferably 0.5-10 parts by weight for 100 parts by weight of the total amount of the components (A) and (B). The component (E) may be used either individually or in combination of two or more.

As examples of the component (E), 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyidiphenylphosphine oxide, bis-(2,6-dimethoxybenzoyl)-2,4,4-trimethylpentylphosphine oxide, and the like can be given.

7. Other Compounds Including Polymerizable Unsaturated Group

As an additive other than the components (A) to (E), other compounds including a polymerizable unsaturated group (component (F)) may be added to the composition of the present invention, if necessary. The component (F) is a compound which includes one polymerizable unsaturated group in the molecule.

As specific examples of the component (F), vinyl group-containing lactams such as N-vinylpyrrolidone and N-vinylcaprolactam, (meth)acrylates having an alicyclic structure such as isobornyl(meth)acrylate, bornyl(meth)acrylate, tricyclodecanyl(meth)acrylate, dicyclopentanyl(meth)acrylate, dicyclopentenyl(meth)acrylate, and cyclohexyl(meth)acrylate; benzyl(meth)acrylate, 4-butylcyclohexyl(meth)acrylate, acryloylmorpholine, vinylimidazole, vinylpyridine, 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, decyl(meth)acrylate, isodecyl(meth)acrylate, undecyl(meth)acrylate, dodecyl(meth)acrylate, lauryl(meth)acrylate, stearyl(meth)acrylate, isostearyl(meth)acrylate, tetrahydrofurfuryl(meth)acrylate, butoxyethyl(meth)acrylate, ethoxydiethylene glycol(meth)acrylate, benzyl(meth)acrylate, phenoxyethyl(meth)acrylate, polyethylene glycol mono(meth)acrylate, polypropylene glycol mono(meth)acrylate, methoxyethylene glycol(meth)acrylate, ethoxyethyl(meth)acrylate, methoxypolyethylene glycol(meth)acrylate, methoxypolypropylene glycol(meth)acrylate, diacetone(meth)acrylamide, isobutoxymethyl(meth)acrylamide, N,N-dimethyl(meth)acrylamide, t-octyl(meth)acrylamide, dimethylaminoethyl(meth)acrylate, diethylaminoethyl(meth)acrylate, 7-amino-3,7-dimethyloctyl(meth)acrylate, N,N-diethyl(meth)acrylamide, N,N-dimethylaminopropyl(meth)acrylamide, hydroxy butyl vinyl ether, lauryl vinyl ether, cetyl vinyl ether, 2-ethylhexyl vinyl ether, a compound shown by the following formula (3), and the like can be given.
CH₂—C(R⁴)—COO(R⁵O)ₚ-Ph-R⁶ (3)
wherein R⁴ represents a hydrogen atom or a methyl group, R⁵ represents an alkylene group having 2-6, and preferably 2-4 carbon atoms, R⁶ represents a hydrogen atom or an alkyl group having 1-12, and preferably 1-9 carbon atoms, Ph represents a phenylene group, and p is an integer of 0-12, and preferably 1-8.

As commercially available products of the component (F), Aronix M-101, M-102, M-111, M-113, M-114, M-117 (manufactured by Toagosei Co., Ltd.), Viscoat LA, STA, IBXA, 2-MTA, #192, #193 (manufactured by Osaka Organic Chemical Industry Co., Ltd.), NK Ester AMP-10G, AMP-20G, AMP-60G (manufactured by Shin-Nakamura Chemical Co., Ltd.), Light Acrylate L-A, S-A, IB-XA, PO-A, PO-200A, NP-4EA, NP-8EA (manufactured by Kyoeisha Chemical Co., Ltd.), FA-511, FA-512A, FA-513A (manufactured by Hitachi Chemical Co., Ltd.), and the like can be given.

8. Additive

Antioxidants, antistatic agents, UV absorbers, light stabilizers, heat polymerization inhibitors, leveling agents, surfactants, and lubricants may be added to the composition of the present invention as other additives. Examples of antioxidants include Irganox 1010, 1035, 1076, 1222 (manufactured by Ciba Specialty Chemicals Co., Ltd.), and the like. Examples of UV absorbers include Tinuvin P234, 320, 326, 327, 328, 213, 329 (manufactured by Ciba Specialty Chemicals Co., Ltd.), Seesorb 102, 103, 501, 202, 712, (manufactured by Shipro Kasei Kaisha, Ltd.), and the like. Examples of light stabilizers include Tinuvin 292, 144, 622LD (manufactured by Ciba Specialty Chemicals Co., Ltd.), Sanol LS770, LS440 (manufactured by Sankyo Co., Ltd.), Sumisorb TM-061 (manufactured by Sumitomo Chemical Co., Ltd.), and the like. Examples of antistatic additives include Larostat additives (manufactured by BASF corp.), Crodastat additives such as Crodastat 1450 (manufactured by Croda Inc.), and the like.

The viscosity of the composition of the present invention thus obtained at 25° C. is usually 1-20,000 mPa·s, and preferably 1-1,000 mPa·s.

9. Non-Conductive Particles

In the present invention, non-conductive particles or particles obtained by reacting non-conductive particles with an alkoxysilane compound in an organic solvent may be used in combination insofar as the curable liquid composition does not separate or gel.

Scratch resistance can be improved by using the non-conductive particles in combination with the oxide particles (component (A)) while maintaining the antistatic function, specifically, maintaining a surface resistivity of the resulting cured product at 10¹²Ω/ [symbol] or less.

There are no specific limitations to the non-conductive particles insofar as the non-conductive particles are particles other than the oxide particles (component (A)). The non-conductive particles are preferably oxide particles other than the component (A) or metal particles. As specific examples of the non-conductive particles, oxide particles such as silicon oxide, aluminum oxide, zirconium oxide, titanium oxide, and cerium oxide, or oxide particles including at least two elements selected from the group consisting of silicon, aluminum, zirconium, titanium, and cerium can be given.

The primary particle diameter of the non-conductive particles determined by measuring the dried powder using the BET adsorption method is preferably 0.1 μm or less, and still more preferably 0.001-0.05 μm. If the primary particle diameter exceeds 0.1 μm, precipitation may occur in the composition, or flatness and smoothness of the resulting film may decrease.

In the case of adding the non-conductive particles to the composition of the present invention, the non-conductive particles may be added after subjecting the non-conductive particles and the alkoxysilane compound to hydrolysis in an organic solvent. This hydrolysis step improves dispersion stability of the non-conductive particles. The hydrolysis of the non-conductive particles and the alkoxysilane compound in an organic solvent may be carried out in the same manner as the conductive particles (component (A)).

Commercially available products of the non-conductive particles are listed below. As examples of commercially available products of silicon oxide particles (silica particles, for example), as colloidal silica, Methanol Silica Sol (MT-ST), IPA-ST, MEK-ST, NBA-ST, XBA-ST, DMAC-ST, ST-UP, ST-OUP, ST-20, ST-40, ST-C, ST-N, ST-O, ST-50, ST-OL (manufactured by Nissan Chemical Industries, Ltd.), and the like can be given. As examples of commercially available products of powdered silica, Aerosil 130, Aerosil 300, Aerosil 380, Aerosil TT600, and Aerosil OX50 (manufactured by Japan Aerosil Co., Ltd.), Sildex H31, H32, H51, H52, H121, H122 (manufactured by Asahi Glass Co., Ltd.), E220A, E220 (manufactured by Nippon Silica Industrial Co., Ltd.), Sylysia 470 (manufactured by Fuji Silysia Chemical Co., Ltd.), SG Flake (manufactured by Nippon Sheet Glass Co., Ltd.), and the like can be given.

As aqueous dispersion products of aluminum oxide (alumina), Alumina Sol-100, -200, -520 (manufactured by Nissan Chemical Industries, Ltd.) can be given. As aqueous dispersion products of zirconium oxide, toluene or methyl ethyl ketone dispersion zirconia sol (manufactured by Sumitomo Osaka Cement Co., Ltd.) can be given. As an aqueous dispersion liquid of cerium oxide, Needral (manufactured by Taki Chemical Co., Ltd.) can be given. As powder or solvent dispersion products of alumina, zirconium oxide, and titanium oxide, NanoTek (manufactured by C.I. Kasei Co., Ltd.) can be given.

The non-conductive particles are added in an amount of preferably 0.1-70 parts by weight, and still more preferably 1-50 parts by weight for 100 parts by weight of the total amount of the components (A) and (B).

Since the curable liquid composition of the present invention includes the solvents used as the components (C) and (D), the component (B) is separated when applying and drying the curable liquid composition by utilizing the difference in solubility of the component (B) between the solvents. As a result, the oxide particles used as the component (A) can be unevenly distributed in the dried film. Therefore, in the cured film and the laminate of the present invention described below, effective conductivity can be realized by the addition of the component (A) in a smaller amount. Moreover, since the amount of the component (A) to be added can be reduced, a film in which absorption and scattering of light caused the component (A) are small and which has higher transparency can be formed.

II. Cured Film and Antistatic Laminate

The cured film of the present invention can be obtained by applying and drying the curable liquid composition, and curing the dried composition by applying radiation.

The surface resistivity of the resulting cured film is 1×10¹²Ω/ [symbol] or less, preferably 1×10¹⁰ Ω/ [symbol] or less, and still more preferably 1×10⁸Ω/ [symbol] or less. If the surface resistivity exceeds 1×10¹²Ω/ [symbol] , antistatic properties may be insufficient, whereby dust may easily adhere, or the adhering dust may not be easily removed. There are no specific limitations to the method of applying the composition. For example, a conventional method such as a roll coating method, spray coating method, flow coating method, dipping method, screen printing method, or ink jet printing method may be used.

There are no specific limitations to the radiation source used to cure the composition insofar as the applied composition can be cured in a short period of time.

As examples of the source of visible rays, sunlight, a lamp, a fluorescent lamp, a laser, and the like can be given. As the source of ultraviolet rays, a mercury lamp, a halide lamp, a laser, and the like can be given. As examples of the source of electron beams, a method of utilizing thermoelectrons produced by a commercially available tungsten filament, a cold cathode method which causes electron beams to be generated by applying a high voltage pulse to a metal, a secondary electron method which utilizes secondary electrons produced by the collision of ionized gaseous molecules and a metal electrode, and the like can be given.

As the source of α-rays, β-rays, and γ-rays, fissionable materials such as ⁶⁰Co can be given. As the source of γ-rays, a vacuum tube which causes accelerated electrons to collide against an anode can be used. The radiation may be applied either individually or in combination of two or more. At least one type of radiation may be applied at specific intervals.

The thickness of the cured film is preferably 0.1-20 μm. In applications such as a touch panel or a CRT in which scratch resistance of the outermost surface is important, the thickness of the cured film is preferably 2-15 μm. In the case of using the cured film as an antistatic film for an optical film, the thickness of the cured film is preferably 0.1-10 μm.

In the case of using the cured film for an optical film, transparency is necessary. Therefore, the total light transmittance of the cured film is preferably 85% or more.

As a substrate to which the cured film of the present invention is applied, a substrate made of a metal, ceramics, glass, plastic, wood, slate, or the like may be used without specific limitations. As a material for making use of high productivity and industrial applicability of radiation curability, it is preferable to apply the cured film to a film-type or fiber-type substrate. A plastic film or a plastic sheet is a particularly preferable material. As examples of plastic, polycarbonate, polymethylmethacrylate, polystyrene/polymethylmethacrylate copolymer, polystyrene, polyester, polyolefin, triacetylcellulose resin, diallylcarbonate of diethylene glycol (CR-39), ABS resin, AS resin, polyamide, epoxy resin, melamine resin, cyclic polyolefin resin (norbornene resin, for example), and the like can be given.

The cured film of the present invention is useful as a hard coat because of its excellent scratch resistance and adhesion. Since the cured film has excellent antistatic properties, the cured film is suitably applied to various substrates such as film-type, sheet-type, or lens-type substrates as an antistatic film.

As application examples of the cured film of the present invention, application as a hard coat for preventing scratches on the surface of the product or adhesion of dust due to static electricity, such as a protective film for touch panels, transfer foil, hard coat for optical disks, film for automotive windows, antistatic protective film for lenses, and surface protective film for a well-designed container for cosmetics; application as an antistatic antireflection film for various display panels such as CRTs, liquid crystal display panels, plasma display panels, and electroluminescence display panels; and application as an antistatic antireflection film for plastic lenses, polarization film, and solar battery panel can be given.

In the case of providing an antireflection function to an optical article, it is known in the art that a method of forming a low-refractive-index layer or a multi-layer structure consisting of a low-refractive-index layer and a high-refractive-index layer on a substrate or a substrate provided with a hard coat treatment is effective. The cured film of the present invention is useful as a layer structure which makes up an antistatic laminate for providing an antireflection function to an optical article. Specifically, an antistatic laminate having antireflection properties can be produced by using the cured film of the present invention in combination with a film having a refractive index lower than that of the cured film.

As the antistatic laminate, a laminate including a coat layer having a thickness of 0.05-0.20 μm and a refractive index of 1.30-1.45 as a low-refractive-index layer formed on the cured film of the present invention can be given. As another examples of the antistatic laminate, a laminate including a coat layer having a thickness of 0.05-0.20 μm and a refractive index of 1.65-2.20 as a high-refractive-index layer formed on the cured film of the present invention, and a coat layer having a thickness of 0.05-0.20 μm and a refractive index of 1.30-1.45 as a low-refractive-index layer formed on the high-refractive-index layer can be given.

In the production of the antistatic laminate, in order to provide other functions such as a non-glare effect, a selective light-absorption effect, weatherability, durability, or transferability, a layer including light scattering particles with a thickness of 1 μm or more, a layer including dyes, a layer including UV absorbers, an adhesive layer, or an adhesive layer and a delamination layer may be added. Moreover, such a function providing component may be added to the antistatic curable composition of the present invention as one of the components.

The antistatic laminate of the present invention is suitably used as a hard coat material for preventing stains or cracks (scratches) on plastic optical parts, touch panels, film-type liquid crystal elements, plastic casing, plastic containers, or flooring materials, wall materials, and artificial marble used for an architectural interior finish; as an adhesive or a sealing material for various substrates; as a vehicle for printing ink; or the like.

### EXAMPLES

The present invention is described in more detail by examples, which should not be construed as limiting the present invention. In the following examples, “part” and “%” respectively refer to “part by weight” and “wt %” unless otherwise indicated.

### Synthesis Example 1

Synthesis of Reactive Surface Treatment Agent

20.6 parts of isophorone diisocyanate were added dropwise to a solution of 7.8 parts of γ-mercaptopropyltrimethoxysilane and 0.2 part of dibutyltin dilaurate in a vessel equipped with a stirrer at 50° C. over one hour in dry air. The mixture was stirred at 60° C. for three hours.

After the addition of 71.4 parts of pentaerythritol triacrylate dropwise at 30° C. for one hour, the mixture was stirred at 60° C. for three hours to obtain a reaction solution.

The residual isocyanate content in the reaction product (reactive surface treatment agent) in the reaction solution was measured by FT-IR and found to be 0.1 wt % or less. This indicates that each reaction was completed almost quantitatively. It was confirmed that the reactive surface treatment agent had a thiourethane bond, a urethane bond, an alkoxysilyl group, and a polymerizable unsaturated group.

### Synthesis Example 2

Synthesis of Reactive Antimony Containing Oxide Micropowder Sol (RA)

A vessel equipped with a stirrer was charged with 95.6 parts of a dispersion liquid of antimony-doped tin oxide (“SNS-101” manufactured by Ishihara Sangyo Kaisha, Ltd., dispersion solvent: isopropyl alcohol, content of antimony-doped tin oxide: 27 wt %, solid content: 30 wt %, average particle diameter: 22 nm, A-2), 4.3 parts of the reactive surface treatment agent synthesized in Synthesis Example 1, 0.1 part of distilled water, and 0.01 part of p-methoxyphenol. The mixture was heated at 65° C. with stirring. After five hours, 0.7 part of methyl orthoformate was added. The mixture was heated for a further one hour at 65° C. with stirring to obtain reactive particles (RA) (dispersion liquid (RA-1)). 2 g of RA-1 was weighed on an aluminum dish and dried on a hot plate at 120° C. for one hour. The dried product was weighed to indicate that the solid content was 32 wt %. 2 g of RA-1 was weighed in a magnetic crucible, predried on a hot plate at 80° C. for 30 minutes, and sintered at 750° C. for one hour in a muffle furnace. The inorganic content in the solid content was determined from the resulting inorganic residue to confirm that the inorganic content was 79 wt %.

Preparation examples of curable liquid compositions are shown in Examples 1-11, and comparative preparation examples are shown in Comparative Examples 1-3. The weight ratio of each component is shown in Table 1. The unit for each component shown in Table 1 is “part by weight”.

### Synthesis Example 3

Synthesis of Reactive Nanosilica Methanol Sol (RA-2)

A vessel equipped with a stirrer was charged with 82.51 parts of a dispersion liquid of Nanosilica particles (“MT-ST” manufactured by Nissan Chemical., dispersion solvent: methanol, content of Nanosilica: 30 wt %, solid content: 30 wt %, average particle diameter: 12 nm,), 7.82 parts of the reactive surface treatment agent synthesized in Synthesis Example 1, and 0.15 part of p-methoxyphenol. The mixture was heated at 55° C. with stirring. After three hours, 1.24 parts of methyl trimethoxy silane was added. The mixture was maintained at 55° C. with stirring. After one hour, 0.83 part of trimethyl orthoformate was added. The mixture was heated for a further one hour at 55° C. with stirring to obtain reactive particles (RA-2) (dispersion liquid (RA-2)). Solid content and inorganic content in the solid content were determined as outlined in Synthesis Example 2.

### Example 1

In a container shielded from ultraviolet rays, 57.3 parts of a dispersion liquid of antimony-doped tin oxide (“SN-100D” manufactured by Ishihara Sangyo Kaisha, Ltd., dispersion solvent: water, content of antimony-doped tin oxide: 30 wt %, average particle diameter: 20 nm, and A-1), 82.8 parts of dipentaerythritol pentaacrylate (“KAYARAD DPHA” manufactured by Nippon Kayaku Co., Ltd. B-1), 40.7 parts of water, 415.7 parts of ethanol, 5.5 parts of 1-hydroxycyclohexyl phenyl ketone, and 2.8 parts of 2-methyl-1-[4-(methylthio)phenyl]-2-morpholinopropanone-1 were stirred at 50° C. for two hours to obtain a homogenous liquid composition. The solid content of the composition and the inorganic content in the solid content were measured in the same manner as in Synthesis Example 1 to find that the solid content and the inorganic content were respectively 18 wt % and 16 wt %. In order to confirm the solubility of B-1 in the solvent, 5 g of B-1 was mixed with 5 g of water and 5 g of ethanol at room temperature, and the mixture was allowed to stand at room temperature for three days. The supernatant liquid of the resulting mixture was dried on a hot plate at 120° C. for one hour and weighed to calculate the solid content. As a result, the solid content and the inorganic content were respectively 0.1 wt % or less and 50 wt %.

### Examples 2-10 and Comparative Examples 1-3

The compositions of Examples 2-10 and Comparative Examples 1-3 shown in Table 1 were obtained by the same operation as described above. Table 2 shows the solubility in the solvent of the compounds (B-1 to B-3) having at least two polymerizable unsaturated groups in the molecule used in the examples. The unit for the values shown in Table 2 is “wt %”.

In the composition of Comparative Example 1, A-1 and B-1 were separated from the solvent.

Preparation of Cured Film

The compositions obtained in Examples 1-10 and Comparative Examples 2-3 were applied to a polyester film (“A4300” manufactured by Toyobo Co., Ltd., thickness: 188 μm or Dupont-Teijin Melinex® #453) using a wire bar coater, and dried in an oven at 80° C. for three minutes to form films. The films were cured by applying ultraviolet rays in air at a dose of 1 J/cm² using a metal halide lamp to obtain cured films (hard coat layers) having a thickness shown in Table 1.

A cured film and a laminate described below could not be formed by using the composition of Comparative Example 1.

Preparation of Laminate (Antistatic Laminate Having Antireflection Properties)

The compositions obtained in Examples 1-6 and Comparative Examples 2-3 were applied to a polyester film (“A4300” manufactured by Toyobo Co., Ltd., thickness: 188 μm) using a wire bar coater, and dried in an oven at 80° C. for one minute to form films. The films were cured by applying ultraviolet rays in air at a dose of 1 J/cm² using a metal halide lamp to obtain cured films (hard coat layers) having a thickness shown in Table 1.

A low-refractive-index coat material (“Opster JN7215” manufactured by JSR corporation, solid content: 3%, refractive index of cured film: 1.41) was applied to the cured film using a wire bar coater (#6), and air-dried at room temperature for five minutes to form films. The films were heated at 140° C. for 10 minutes by using an oven to form low-refractive-index films having a thickness of 0.1 □m to obtain antistatic laminates having antireflection properties.

Evaluation of Cured Film and Laminate

Scratch resistance, total light transmittance, and surface resistivity of the cured film and the laminate were evaluated according to the following criteria. The reflectance of the laminate was evaluated according to the following measurement method.

(1) Scratch Resistance

The surfaces of the cured product and antireflection film laminate were rubbed with #0000 steel wool 30 times at a load of 200 g/cm² to evaluate the scratch resistance of the cured product and antireflection film laminate by naked eye observation according to the following criteria. The results are shown in Table 1.
Grade 5: No scratch was observed.
Grade 4: 1-5 scratches were observed.
Grade 3: 6-50 scratches were observed.
Grade 2: 51-100 scratches were observed.
Grade 1: Peeling of film was observed.

A cured product or laminate with a scratch resistance of grade 3 or more is allowable in actual application. A cured product or laminate with a scratch resistance of grade 4 or more is preferable since excellent durability is obtained in actual application. A cured product or laminate with a scratch resistance of grade 5 is still more preferable since durability in actual application is significantly improved.

(2) Reflectance

The reflectance (minimum reflectance in measurement wavelength region) of the laminate was measured at a wavelength of 340-700 nm using a spectral reflectance measurement system (spectrophotometer “U-3410” manufactured by Hitachi Ltd. equipped with large sample compartment integrating sphere “150-09090”) according to JIS K7105 (measurement method A).

Specifically, the minimum reflectance of the laminate (antireflection film) at each wavelength was measured while using the reflectance of a deposited aluminum film as a standard (100%). The results are shown in Table 1.

(3) Total Light Transmittance

The total light transmittance of the cured film and the laminate was measured according to JIS K7105 using a color haze meter (manufactured by Suga Test Instruments Co., Ltd.,) for example 1-6 and comparative examples 1-3 or Haze-gard plus model (manufactured by BYK-Gardner Corp.) for example 7-10. The results are shown in Table 1.

(4) Surface Resistivity

The surface resistivity (Ω/ [symbol] ) of the cured film and the laminate was measured using a high resistance meter (“Agilent 4339B” manufactured by Agilent Technologies) and a resistivity cell (“16008B” manufactured by Agilent Technologies) for examples 1-6 and comparative examples 1-3 or Keithley model 65017A electrometer (for examples 7-10) with model 8009 resistivity test fixture at an applied voltage of 100 V. The results are shown in Table 1.

(5) Pencil Hardness

The pencil hardness of cured films was measured as an alternative to scratch resistance in examples 7-10. Pencil hardness was measured as per ASTM D3363 utilizing standardized hardness testing pencils (available from Paul N. Gardner Corp.)

In Table 1, the amount of the oxide particles (A) and the reactive particles (RA) indicates the weight of dry fine powder included in each dispersion sol (excluding organic solvent).

TABLE I
with added formulations

| | Example | | | | | | |
|---|---|---|---|---|---|---|---|
| | 1 | 2 | 3 | 4 | 5 | 6 | 7 |
| Oxide | | | | | | | |
| particles (A) | | | | | | | |
| A-1 | 17.2 | 17.2 | 8.7 | — | — | — | |
| A-2 | — | — | — | — | — | 16.5 | |
| A-3 | — | — | — | — | — | — | |
| A-4 | — | — | — | 17.2 | — | — | |
| A-5 | | | | | | | 5.0 |
| Reactive | | | | | | | |
| particles (RA) | | | | | | | |
| RA-1 | — | — | — | — | 41.3 | — | |
| RA-2 | | | | | | | 39.0 |
| Compound | | | | | | | |
| (B) having at | | | | | | | |
| least two | | | | | | | |
| polymerizable | | | | | | | |
| unsaturated | | | | | | | |
| groups in | | | | | | | |
| molecule | | | | | | | |
| B-1 | 82.8 | 82.8 | 61.1 | 82.8 | — | — | |
| B-2 | — | — | 30.2 | — | — | — | |
| B-3 | — | — | — | — | 58.7 | 83.5 | |
| B-1 | | | | | | | 16.9 |
| B-4 | | | | | | | 11.2 |
| Solvent (C) In | | | | | | | |
| which | | | | | | | |
| solubility of | | | | | | | |
| compound | | | | | | | |
| (B) is less | | | | | | | |
| than 10% | | | | | | | |
| Water | 80.8 | 40.1 | 111.5 | 46.5 | — | — | |
| IPA | — | — | — | — | 87.8 | 39.3 | |
| Butanol | | | | | | | 25.0 |
| Xylene | | | | | | | |
| 1-Methoxy-2- | | | | | | | |
| Propanol | | | | | | | |
| 1-Methoxy-2- | | | | | | | |
| Propanol | | | | | | | |
| Acetate | | | | | | | |
| Solvent (C) In | | | | | | | |
| which | | | | | | | |
| solubility of | | | | | | | |
| compound | | | | | | | |
| (B) is 10% or | | | | | | | |
| more | | | | | | | |
| MeOH | — | — | 392.6 | 448.9 | 405.6 | 417.8 | 65.6 |
| EtOH | 415.7 | 122.1 | — | — | — | — | |
| IPA | — | — | — | — | — | — | |
| Photoinitiator | | | | | | | |
| (E) | | | | | | | |
| E-1 | 5.5 | 5.5 | 6 | 5.5 | 5.5 | 2.8 | 1.9 |
| E-2 | 2.8 | 2.8 | 3 | 2.8 | 2.8 | 1.4 | 1.1 |
| Additive | | | | | | | |
| F-1 | | | | | | | 0.2 |
| F-2 | | | | | | | 24.8 |
| Total | 604.8 | 270.5 | 613.1 | 603.7 | 601.7 | 561.3 | 190.6 |
| Solid content | 18 | 40 | 18 | 18 | 18 | 19 | 52.5 |
| (%) | | | | | | | |
| Inorganic | 16 | 16 | 8 | 17 | 30 | 14 | 27 |
| content (%) In | | | | | | | |
| solid content | | | | | | | |
| Appearance | Uniform | Uniform | Uniform | Uniform | Uniform | Uniform | Uniform |
| of liquid | | | | | | | |
| composition | | | | | | | |
| Cured film | | | | | | | |
| properties | | | | | | | |
| Film | 4 | 4 | 1 | 4 | 4 | 4 | 4 |
| thickness | | | | | | | |
| (μm) | | | | | | | |
| Total light | 89 | 88 | 90 | 90 | 86 | 88 | 88 |
| transmittance | | | | | | | |
| (%) | | | | | | | |
| Scratch | 5 | 5 | 5 | 5 | 5 | 5 | 5 |
| resistance | | | | | | | |
| Surface | 7 × 10⁷ | 7 × 10⁷ | 2 × 10⁸ | 7 × 10⁶ | 5 × 10¹¹ | 9 × 10⁹ | 7 × 10⁸ |
| resistivity | | | | | | | |
| (Ω/ [symbol] ) | | | | | | | |
| Laminate | | | | | | | |
| properties | | | | | | | |
| Reflectance | 0.8 | 0.8 | 0.5 | 1.3 | 0.8 | 81.1 | |
| (%) | | | | | | | |
| Total light | 89 | 89 | 90 | 90 | 86 | 88 | |
| transmittance | | | | | | | |
| (%) | | | | | | | |
| Pencil | | | | | | | H/2H |
| Hardness | | | | | | | |
| Scratch | 5 | 5 | 5 | 3 | 3 | 3 | |
| resistance | | | | | | | |
| Surface | 8 × 10⁷ | 8 × 10⁷ | 1 × 10⁸ | 8 × 10⁷ | 8 × 10¹¹ | 3 × 10¹⁰ | |
| resistivity | | | | | | | |
| (Ω/ [symbol] ) | | | | | | | |

| | Example | | | Comparative Example | | |
|---|---|---|---|---|---|---|
| | 8 | 9 | 10 | 1 | 2 | 3 |
| Oxide | | | | | | |
| particles (A) | | | | | | |
| A-1 | | | | 17.2 | — | — |
| A-2 | | | | — | 16.5 | 16.5 |
| A-3 | | | | — | — | — |
| A-4 | | | | — | — | — |
| A-5 | 5.0 | 5.0 | 5.0 | | | |
| Reactive | | | | | | |
| particles (RA) | | | | | | |
| RA-1 | | | | — | — | — |
| RA-2 | 39.0 | 39.0 | 39.0 | | | |
| Compound | | | | | | |
| (B) having at | | | | | | |
| least two | | | | | | |
| polymerizable | | | | | | |
| unsaturated | | | | | | |
| groups in | | | | | | |
| molecule | | | | | | |
| B-1 | | | | 82.8 | — | 83.5 |
| B-2 | | | | — | — | — |
| B-3 | | | | — | 83.5 | — |
| B-1 | 16.9 | 16.9 | 16.9 | | | |
| B-4 | 11.2 | 11.2 | 11.2 | | | |
| Solvent (C) In | | | | | | |
| which | | | | | | |
| solubility of | | | | | | |
| compound | | | | | | |
| (B) is less | | | | | | |
| than 10% | | | | | | |
| Water | | | | 273 | — | — |
| IPA | | | | — | — | — |
| Butanol | | | | | | |
| Xylene | 25.0 | | | | | |
| 1-Methoxy-2- | | 25.0 | | | | |
| Propanol | | | | | | |
| 1-Methoxy-2- | | | 25.0 | | | |
| Propanol | | | | | | |
| Acetate | | | | | | |
| Solvent (C) In | | | | | | |
| which | | | | | | |
| solubility of | | | | | | |
| compound | | | | | | |
| (B) is 10% or | | | | | | |
| more | | | | | | |
| MeOH | 65.6 | 65.6 | 65.6 | 223.5 | 457.1 | 417.8 |
| EtOH | | | | — | — | — |
| IPA | | | | — | — | 39.3 |
| Photoinitiator | | | | | | |
| (E) | | | | | | |
| E-1 | 1.9 | 1.9 | 1.9 | 5.5 | 2.8 | 2.8 |
| E-2 | 1.1 | 1.1 | 1.1 | 2.8 | 1.4 | 1.4 |
| Additive | | | | | | |
| F-1 | 0.2 | 0.2 | 0.2 | | | |
| F-2 | 24.8 | 24.8 | 24.8 | | | |
| Total | 190.6 | 190.6 | 190.6 | 604.8 | 561.3 | 561.3 |
| Solid content | 52.5 | 52.5 | 52.5 | 18 | 19 | 19 |
| (%) | | | | | | |
| Inorganic | 27 | 27 | 27 | 16 | 14 | 14 |
| content (%) In | | | | | | |
| solid content | | | | | | |
| Appearance | Uniform | Uniform | Uniform | Separat- | Uniform | Uniform |
| of liquid | | | | ed | | |
| composition | | | | | | |
| Cured film | | | | | | |
| properties | | | | | | |
| Film | 4 | 4 | 4 | Could | 4 | 4 |
| thickness | | | | not | | |
| (μm) | | | | meas- | | |
| | | | | ured | | |
| | | | | due to | | |
| | | | | separa- | | |
| | | | | tion | | |
| Total light | 88 | 88 | 88 | | 83 | 88 |
| transmittance | | | | | | |
| (%) | | | | | | |
| Scratch | 5 | 5 | 5 | | 5 | 5 |
| resistance | | | | | | |
| Surface | 7 × 10⁸ | 7 × 10⁸ | 7 × 10⁸ | | 4 × 10¹⁴ | 3 × 10¹³ |
| resistivity | | | | | | |
| (Ω/ [symbol] ) | | | | | | |
| Laminate | | | | | | |
| properties | | | | | | |
| Reflectance | | | | | 0.9 | 1.1 |
| (%) | | | | | | |
| Total light | | | | | 83 | 88 |
| transmittance | | | | | | |
| (%) | | | | | | |
| Pencil | H/2H | H/2H | H/2H | | | |
| Hardness | | | | | | |
| Scratch | | | | | 4 | 3 |
| resistance | | | | | | |
| Surface | | | | | 8 × 10¹⁴ | 2 × 10¹⁴ |
| resistivity | | | | | | |
| (Ω/ [symbol] ) | | | | | | |

The meanings of the abbreviations shown in Table 1 are as follows.
A-1: ATO aqueous dispersion sol (“SN-100D” manufactured by Ishihara Sangyo Kaisha, Ltd., ATO content: 30 wt %, number average primary particle diameter: 20 nm)
A-2: ATO isopropyl alcohol dispersion sol (“SNS-101” manufactured by Ishihara Techno Corp., solid content: 30%, ATO content: 27%, number average primary particle diameter: 22 nm)
A-3: ATO methyl ethyl ketone dispersion sol (“SNS-10M” manufactured by Ishihara Techno Corp., solid content: 30%, ATO content: 27%, number average primary particle diameter: 20 nm)
A-4: ITO aqueous dispersion sol (“Passtran ITO dispersion liquid (water)” manufactured by Mitsui Mining & Smelting Co., Ltd., solid content: 27%, ITO content: 27%, number average primary particle diameter: 20 nm)
A-5: Antimony pentoxide/mixed oxide dispersion sol in methanol (“AMT 130S” manufactured by Nissan Chemical Inc., solid content 30.8%, number average primary particle diameter: <7 nm)
RA-1: Reactive ATO sol prepared in Synthesis Example 2
RA-2: Reactive Nanosilica sol in methanol as prepared in Synthesis Example 3
B-1: Dipentaerythritol hexaacrylate
B-2: Tricyclodecanediyldimethanol diacrylate
B-3: Tris(2-hydroxyethyl)isocyanurate triacrylate
B-4—Ethoxylated Trimethylolpropane triacrylate, 9 molar equivalent degrees of ethoxylation (SR 502 manufactured by Sartomer Co.)
IPA: Isopropyl alcohol
MeOH: Methanol
EtOH: Ethanol
E-1: 1-Hydroxycyclohexyl phenyl ketone
E-2: 2-Methyl-1-[4-(methylthio)phenyl]-2-morpholinopropanone-1
F-1: 1,3,5-tris(3,5-di-tert-butyl-4-hydroxybenzyl)-1,3,5-triazine-2,4,6(1H,3H,5H)-trione (Irganox 3114 manufactured by Ciba Specialty Chemicals Corp.)

F-2: sulfonamide ethoxylate silicone copolymer, proprietary antistatic additive mixture (Larostat HTS905, manufactured by BASF Corp.)

TABLE 2

| Solvent | B-1 | B-2 | B-3 |
|---|---|---|---|
| Water | <0.1 wt % | <0.1 wt % | 1.2 wt % |
| IPA | ≧50 wt % | ≧50 wt % | 7.1 wt % |
| MeOH | ≧50 wt % | ≧50 wt % | 49 wt % |
| EtOH | ≧50 wt % | ≧50 wt % | 1.8 wt % |

### EFFECT OF THE INVENTION

As described above, the present invention can provide a curable liquid composition excelling in storage stability and curability and capable of forming a coat (film) which excels in antistatic properties, hardness, scratch resistance, and transparency on the surface of various substrates, a cured film of the composition, and an antistatic laminate.

1. A curable liquid composition comprising:
(A) particles including an oxide of at least one element selected from the group consisting of indium, antimony, zinc, and tin as a major component,
(B) a compound having at least two polymerizable unsaturated groups in the molecule,
(C) a solvent in which solubility of the component (B) is less than 10 wt %, and
(D) a solvent in which solubility of the component (B) is 10 wt % or more, the components (A) and (B) being uniformly dispersed or dissolved in the composition.

2. The curable liquid composition according to claim 1, further comprising (E) a photoinitiator.

3. The curable liquid composition according to claim 1, wherein the component (A) is particles including either antimony-doped tin oxide (ATO) or tin-doped indium oxide (ITO) as a major component.

4. The curable liquid composition according to claim 1, wherein the component (A) is oxide particles surface-treated by using a surface treatment agent.

5. The curable liquid composition according to claim 4, wherein the surface treatment agent is a compound including at least two polymerizable unsaturated groups, a group shown by the following formula (1),
—X—C(═Y)—NH— (1)
wherein X represents NH, O (oxygen atom), or S (sulfur atom), and Y represents O or S, and a silanol group or a group which forms a silanol group by hydrolysis.

6. The curable liquid composition according to claim 5, wherein the group shown by the formula (1) is at least one group selected from the group consisting of —O—C(═O)—NH—, —O—C(═S)—NH—, and —S—C(═O)—NH—.

7. The curable liquid composition according to claim 1, wherein the component (C) is water, the content of water in the total solvent in the composition being 0.1-50 wt %.

8. The curable liquid composition according to claim 1, wherein the component (C) is an organic solvent, the content of the organic solvent in the total solvent in the composition being 5-95 wt %.

9. The curable liquid composition according to claim 1, wherein the solid content of the composition is at least 50%.

10. A cured film obtained by curing the curable liquid composition according to claim 1, the cured film having surface resistivity of 1×10¹² Ω/ [symbol] or less.

11. A process for producing a cured film, comprising a step of curing the curable liquid composition according to claim 1 by applying radiation to the composition.

12. An antistatic laminate comprising a layer of a cured film obtained by curing the curable liquid composition according to claim 1.

13. The antistatic laminate according to claim 11, wherein the thickness of the layer of the cured film is 0.1-20 □m.
